(19) United States
(12) Patent Application Publication
(10) Pub. No.: US 2006/0229949 A1
(43) Pub. Date: Oct. 12, 2006

(54) Purchase of services

(75) Inventor: Martin Paul Moshal, Marina Bay (GI)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: WATERLEAF LIMITED

(21) Appl. No.: 10/515,780

(22) PCT Filed: May 22, 2003
(86) PCT No.: PCT/IB03/01952

§ 371 Date: Apr. 3, 2006

(30) Foreign Application Priority Data
May 24, 2002 (GB) 0212012.9

(51) Int. Cl. G06Q 30/00

(52) U.S. Cl. 705/26

(57) ABSTRACT

A system for the purchase of services comprises: a selection means operable by a purchaser to select one or more desired service providing means from a number of different available service providing means, each of the different service providing means being activatable to provide a corresponding service to the purchaser against the consumption of credit; a payment facility capable of receiving payment for the provision of the desired services; a dispensing facility responsive to receipt of payment from the purchaser to make available the selected one or more service providing means to the purchaser; and a credit supply means responsive to receipt of payment at from the purchaser to supply the purchaser with a predetermined amount of credit. The predetermined amount of credit is a function of a number of different desired service providing means that are selected by the purchaser, while the payment required from the purchaser is also a function of the number of different desired service providing means selected by the purchaser. Any unconsumed credit supplied to the purchaser expires at a from the purchaser, or upon the occurrence providing means is an executable software program.

### FIELD OF THE INVENTION

This invention relates to a system for the purchase of services and, more particularly, to a system for the purchase of a licence to use a software program. The invention extends to a method for purchasing services.

### BACKGROUND TO THE INVENTION

It is known for a holder (“the licensoer”) of any Intellectual Property rights, such as copyright, patents, know-how and the like, embodied in a software program, to grant a licence to another party (“the licensee”) to use the software program subject to certain terms and conditions.

One of these conditions is usually the payment of a licence fee, which may be a single, or a recurring, licence fee. Such a licence can be either indefinite, or endure for a fixed period, after which the licence to use the software program terminates. Where a recurring licence fee is paid, the licence is usually granted for a fixed period and is renewable for a further such period upon payment of the recurring licence fee. In this manner, the holder of the Intellectual Property rights exploits the software program in order to derive revenue and benefit therefrom, while at the same time retaining ownership of the rights embodied in the software program.

Thus, such licences are either perpetual or limited in time. Provided that the licensee complies with the time limitations of the licence, and makes the necessary licence fee payment to the licensor, he may be free to use the software program without any further substantive restrictions or limitations.

It is also known, however, for a software program to be licensed under a restriction limiting the number of times that it can be installed on a computer workstation, ready for execution.

These prior art methods of regulating the use of legitimately licensed software programs are disadvantageous for the licensee and the licensor, as they are unnecessarily inflexible for the licensee, and require diligent administration by the licensor.

### OBJECT OF THE INVENTION

It is an object of this invention to provide a system and a method for the purchase of services that will, at least partially, alleviate the abovementioned difficulties and disadvantages.

### SUMMARY OF THE INVENTION

In accordance with this invention there is provided a system for the purchase of services, comprising:

selection means operable by a purchaser to select at least one desired service providing means from a number of different available service providing means, each of the different service providing means being activatable to provide a corresponding service to the purchaser against the consumption of credit;

a payment facility capable of receiving payment for the provision of the at least one desired service;

a dispensing facility responsive to receipt of payment from the purchaser to make available the selected at least one service providing means to the purchaser; and

a credit supply means responsive to receipt of payment from the purchaser to supply the purchaser with a predetermined amount of credit, the predetermined amount of credit being a function of the at least one desired service providing means selected by the purchaser on the selection means.

Further features of the invention provide for the selection means to be operable by the purchaser to select a plurality of different service providing means from the number of available service providing means, for the dispensing facility to be responsive to receipt of payment from the purchaser to make available the plurality of different selected service providing means to the purchaser, and for the credit supply means to be responsive to receipt of payment by the purchaser to supply the purchaser with a predetermined amount of credit that is a function of a number of different desired service providing means selected by the purchaser on the selection means.

Still further features of the invention provide for any unconsumed credit supplied to the purchaser to expire at a predetermined time after receipt of payment from the purchaser, alternatively for the unconsumed credit supplied to the purchaser to expire upon the occurrence of a predetermined event, and for the payment required from the purchaser to be a function of the number of different desired service providing means selected by the purchaser on the selection means.

Yet further features of the invention provide for each service providing means to become deactivated from providing the corresponding service to the purchaser at a predetermined time after receipt of payment from the purchaser, alternatively for the service providing means to become deactivated from providing the corresponding service to the purchaser upon the occurrence of a predetermined event.

There is also provided for the rate at which credit is consumed by any one of the number of different available service providing means to be random, and for the random rate of consumption to include both positive and negative rates of consumption.

There is further provided for the at least one service providing means to be an executable software program, preferably a gaming software program, further preferably a casino gaming software program.

The invention extends to a method for the purchase of services, comprising the steps of:

selecting at least one desired service providing means from a number of different available service providing means, each of the different available service providing means being activatable to provide a corresponding service to a purchaser thereof, against the consumption of credit; receiving payment from the purchaser for the provision of the at least one desired service;

making available the selected at least one service providing means to the purchaser in response to receipt of payment from the purchaser; and supplying the purchaser with a predetermined amount of credit in response to receipt of payment from the purchaser, the predetermined amount of credit being a function of the at least one desired service providing means selected by the purchaser.

There is further provided for selecting a plurality of different service providing means from the number of available service providing means, for making available the plurality of different selected service providing means to the purchaser upon receipt of payment from the purchaser, the predetermined amount of credit being a function of a number of different desired service providing means selected by the purchaser.

There is still further provided for causing any unconsumed credit supplied to the purchaser to expire at a predetermined time after receipt of payment from the purchaser, alternatively for causing any unconsumed credit supplied to the purchaser to expire upon the occurrence of a predetermined event, and for determining the payment required from the purchaser to be a function of the number of different desired service providing means selected by the purchaser.

There is yet further provided for deactivating each service providing means from providing the corresponding service to the purchaser at a predetermined time after receipt of payment from the purchaser, alternatively for deactivating each service providing means from providing the corresponding service to the purchaser upon the occurrence of a predetermined event.

There is also provided for causing the rate at which credit is consumed by any one of the number of different available service providing means to be random, and for enabling the random rate of consumption of credit to be both positive and negative.

There is also provided for the at least one service providing means to be an executable software program, preferably a gaming software program, further preferably a casino gaming software program, and for the method to include the step of placing a wager associated with a turn of the casino gaming software program.

### BRIEF DESCRIPTION OF THE DRAWINGS

A preferred embodiment of the invention is described below, by way of example only, and with reference to the accompanying drawings, in which:

FIG. 1 is a schematic representation of a system for the purchase of services, according to the invention.

### DETAILED DESCRIPTION OF THE INVENTION

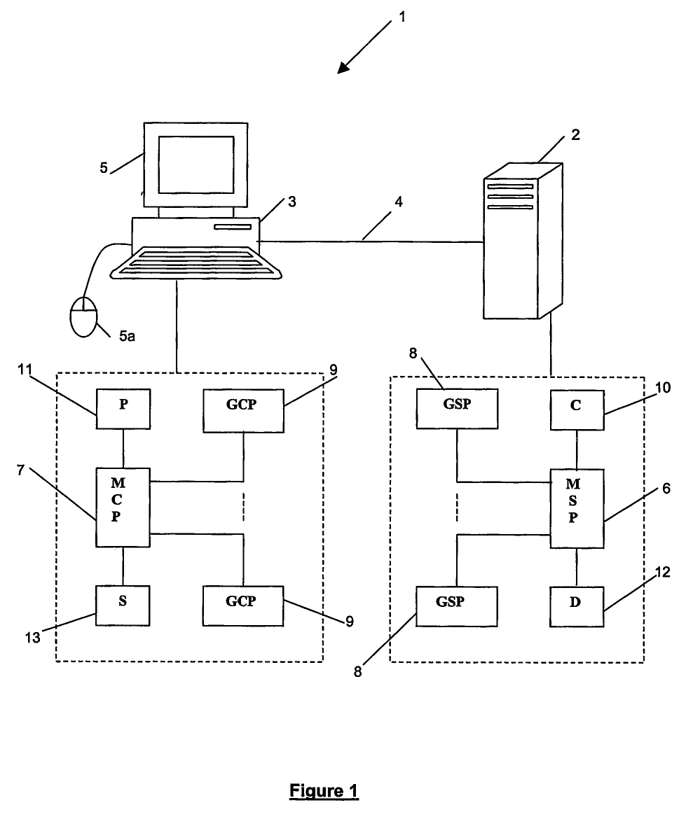

Referring to FIG. 1, a system for the purchase of services is indicated generally by reference (1).

This embodiment of the invention is described with particular reference to the purchase of gaming services and, in particular, to the purchase of casino gaming services. It is to be clearly understood, however, that the scope of the invention is not limited to this particular application.

The system (1) includes a gaming server (2) and a player access facility in the form of a computer workstation (3) having a display screen (5) and an associated pointing device (5a), such as a mouse or, alternatively, a touchpad. The computer workstation (3) is remote from the gaming server (2) and is in communication therewith by means of a communication network (4) that is, in this embodiment, the Internet.

The computer workstation (3) is a conventional personal computer operating under a Windows 2000 operating system, which is well known and commercially available from the Microsoft Corporation of Seattle, Wash., USA. The computer workstation (3) and the gaming server (2) each execute different components of one or more available casino games, under instruction of a player through a suitable man-machine interface (not shown) in the form of a graphical user interface (GUI) on the computer workstation (3). Each one of the available casino games provides a service by means of which a different game can be played against the consumption of credit provided to the player. In the specification, the term “purchaser will be used to refer to a player of any of the available casino games, for convenience.

The system (1) includes a master server process (6), which is executable in the gaming server (2), and a corresponding master client process (7) that is executable in the computer workstation (3). The master client process (7) provides the purchaser with a selection means (13) that can be used by the purchaser to select one or more desired service providing means, in the form of the casino games, in respect of which he wishes to procure the rights to play the games. The selection means (13) consists of a display list on the display screen (5) of all the available casino games, each having a corresponding checkbox that can be selected by the purchaser with the pointing device (5a) if the particular casino gaming is one that is of interest to the purchaser. The purchaser is able to select any one or more of the games in the display list.

Once the purchaser has made the desired selection of casino games in this manner, he is required to make payment for the selected casino games. The payment required from the purchaser is a function of the number of different casino games that the purchaser has selected on the selection means (13), the greater the number of available casino games selected, the greater the payment required by the purchaser. The purchaser may be encouraged to select more than one casino game by making the unit price per game inversely proportional to a number of available casino games that are selected. In this embodiment, this is achieved by pricing one game at 20 currency units, three games at 50 currency units, five games at 80 currency units, seven games at 100 currency units, and 12 games at 149 currency units. The master client process (7) also provides the purchaser with a payment facility (11) by means of which the purchaser is able to make payment for the selected casino games. Payment may be made by means of a token such as a debit card, a credit card and the like.

Once the purchaser has made payment for the selected casino games, the master server process (6) establishes a dispensing facility (12), in the form of a download process, which downloads the selected casino games to the purchaser's computer workstation (3) for play by the purchaser. Each casino game consists of a game server process (8), which is executable in the gaming server (2), and a corresponding game client process (9), which is executable in the computer workstation (3). The game server process (8) generates, upon request of the game client process (9), a random event that determines an outcome of the casino game. The game client process (9) obtains the result of the random event and displays this result to the player of the game on the display screen (5) in an intelligible manner according to the design of the game.

Each casino game is playable against the consumption of credit. The master server process (6) also includes a credit supply means (10), which provides the purchaser with a predetermined amount of credit that is consumable by the purchaser to play any of the casino games. Any of the downloaded casino games can be played in this manner until the predetermined amount of credit has been consumed.

The credit supplied to the purchaser by the credit supply means (10) to the purchaser is a function of the number of games selected for download by the purchaser on the selection means (13). In this embodiment, the number of units of credit supplied by the credit supply means (10) to the purchaser against the number of selected games is outlined in the table below.

| Number of Games | Units of Credit |
|---|---|
| 1 | 15 |
| 2 | 50 |
| 3 | 85 |
| 4 | 105 |
| 5 | 160 |

As with the pricing of the available casino games, the credit supplied to the purchaser by the credit supply means (10) may be used to encourage the purchaser to select more games by making the credit supplied to the purchaser a nonlinear function of the number of games selected by the purchaser. This is clearly illustrated in the table above.

Once all of the credit provided to the purchaser has been consumed in playing the games, the master client process (7) disables the downloaded casino games for any further use by the purchaser. If the purchaser wishes to continue playing the games, he is required to repeat the cycle by again selecting any number of desired casino games, which will be made available to the purchaser together with a corresponding amount of credit, as described above, ready for further play.

The casino games that are available to the player include the games of video slots, roulette, blackjack, or video poker, for example. These games are well known in the art and will not be described here in detail.

Numerous modifications are possible to this embodiment without departing from the scope of the invention. In particular, the system (1) is directly applicable to the purchase of services other than the casino games described above. Further, the system (1) can be applied to enable the purchase of gaming services in self-contained apparata that do not operate an on-line environment as described above, such as electronic gaming devices of the type commonly found in land-based casinos, or hand-held gaming devices. Still further, the relationship between, on the one hand, the number of available games selected by the purchaser and the payment required from the purchaser and between, on the other hand, the number of available games selected and a corresponding amount of credit provided to the purchaser, may be different to those illustrated above. Yet further, the progress of a plurality of successive turns of the various casino games selected and made available to the purchaser may be automatically controlled in order not to burden the purchaser with a necessity of making repetitive actions and game play decisions.

Additionally, any unconsumed credit may be caused to expire at a predetermined time after receipt of payment from the purchaser for the selected casino games, or after downloading of the casino games. Additionally, the unconsumed credit can be caused to expire upon the occurrence of a specific event, such as disconnection of the computer workstation (3) from the communication network (4).

Still further, irrespective of the fact that the purchaser may have unexpired credit, each casino game may be deactivated at a predetermined time after receipt of payment from the purchaser for the selected casino games, or after downloading of the casino games. Alternatively, the casino games may be deactivated upon the occurrence of a specific event, such as disconnection of the computer workstation (3) from the communication network (4).

Finally, the download process may, for reasons of efficiency, unconditionally download all the available casino games in a background mode, the casino games being disabled for use. Only once the purchaser has selected the casino games that are of interest to him and has paid for them, are the selected casino games enabled for use.

The invention therefore provides a novel system for purchasing services against the consumption of credit, in which the cost of payment for such services is not directly equivalent to credit supplied for the provision of the services.

1. A system for the purchase of services, comprising:
selection means operable by a purchaser to select at least one desired service providing means from a number of different available service providing means, each of the different service providing means being activatable to provide a corresponding service to the purchaser against the consumption of credit;
a payment facility capable of receiving payment for the provision of the at least one desired service;
a dispensing facility responsive to receipt of payment from the purchaser to make available the selected at least one service providing means to the purchaser; and
a credit supply means responsive to receipt of payment from the purchaser to supply the purchaser with a predetermined amount of credit, the predetermined amount of credit being a function of the at least one desired service providing means selected by the purchaser on the selection means.

2. A system as claimed in claim 1 in which the selection means is operable by the purchaser to select a plurality of different service providing means from the number of available service providing means, the dispensing facility being responsive to receipt of payment from the purchaser to make available the plurality of different selected service providing means to the purchaser.

3. A system as claimed in claim 2 in which the credit supply means is responsive to receipt of payment by the purchaser to supply the purchaser with a predetermined amount of credit that is a function of a number of different desired service providing means selected by the purchaser.

4. (canceled)

5. A system as claimed in claim 1 in which any unconsumed credit supplied to the purchaser expires at a predetermined time after receipt of payment from the purchaser.

6. A system as claimed in claim 3 in which any unconsumed credit supplied to the purchaser expires upon the occurrence of a predetermined event.

7. A system as claimed in claim 2 in which the payment required from the purchaser is a function of the number of different desired service providing means selected by the purchaser on the selection means.

8. A system as claimed in claim 2 in which each service providing means becomes deactivated from providing the corresponding service to the purchaser at a predetermined time after receipt of payment from the purchaser.

9. A system as claimed in claim 2 in which each service providing means becomes deactivated from providing the corresponding service to the purchaser upon the occurrence of a predetermined event.

10. A system as claimed in claim 2 in which the rate at which credit is consumed by any one of the number of different available service providing means is random, the random rate of consumption including both positive and negative rates of consumption.

11. (canceled)

12. A system as claimed in any one of the preceding claims in which the at least one service providing means is an executable software program.

13. A system as claimed in claim 12 in which the executable software program is a casino gaming software program.

14. (canceled)

15. A method for the purchase of services, comprising the steps of:
selecting at least one desired service providing means from a number of different available service providing means, each of the different available service providing means being activatable to provide a corresponding service to a purchaser thereof, against the consumption of credit;
receiving payment from the purchaser for the provision of the at least one desired service;
making available the selected at least one service providing means to the purchaser in response to receipt of payment from the purchaser; and
supplying the purchaser with a predetermined amount of credit in response to receipt of payment from the purchaser, the predetermined amount of credit being a function of the at least one desired service providing means selected by the purchaser.

16. A method as claimed in claim 15 that includes steps of:
selecting a plurality of different service providing means from the number of available service providing means: and
making available the plurality of different selected service providing means to the purchaser upon receipt of payment from the purchaser, the predetermined amount of credit being a function of a number of different desired service providing means selected by the purchaser.

17. (canceled)

18. A method as claimed in either one of claims 15 or 16 in which any unconsumed credit supplied to the purchaser is caused to expire at a predetermined time after receipt of payment from the purchaser.

19. A method as claimed in either one of claims 15 or 16 in which any unconsumed credit supplied to the purchaser is caused to expire upon the occurrence of a predetermined event.

20. A method as claimed in claim 16 in which the payment required from the purchaser is determined as a function of the number of different desired service providing means selected by the purchaser.

21. A method as claimed in claim 16 in which each service providing means is deactivated from providing the corresponding service to the purchaser at a predetermined time after receipt of payment from the purchaser.

22. A method as claimed in claim 16 in which each service providing means is deactivated from providing the corresponding service to the purchaser upon the occurrence of a predetermined event.

23. A method as claimed in claim 16 in which a rate at which credit is consumed by any one of the number of different available service providing means is random, the random rate of consumption including both positive and negative rates of consumption.

24. (canceled)

25. A method as claimed in claim 15 in which the at least one service providing means is an executable software program.

26. A method as claimed in claim 25 in which the executable software program is a casino gaming software program.

27. (canceled)

28. A method as claimed in claim 26 that includes a step of placing a wager associated with a turn of the casino gaming software program.
